(19) United States
(12) Patent Application Publication
(10) Pub. No.: US 2017/0052349 A1
(43) Pub. Date: Feb. 23, 2017

(54) WIDE-ANGLE LENS ASSEMBLY

(71) Applicants: Sintai Optical (Shenzhen) Co., Ltd., Shenzhen City (CN); Asia Optical International Ltd., Tortola (GB)

(72) Inventor: CHING-CHUNG YEH, Taichung (TW)

(21) Appl. No.: 15/241,134

(22) Filed: Aug. 19, 2016

(30) Foreign Application Priority Data
Aug. 21, 2015 (CN) 201510520031.4

(51) Int. Cl. G02B 13/00; G02B 9/60; G02B 27/00; G02B 13/04

(52) U.S. Cl. CPC G02B 13/0045; G02B 13/04; G02B 9/60; G02B 27/0025

(57) ABSTRACT

A wide-angle lens assembly includes a first lens, a second lens, a third lens, a fourth lens, a fifth lens and a sixth lens, all of which are arranged in sequence from an object side to an image side along an optical axis. The first lens is a meniscus lens with negative refractive power and includes a convex surface facing the object side. The second lens is a biconcave lens with negative refractive power. The third lens is with positive refractive power. The fourth lens is with positive refractive power. The fifth lens is a meniscus lens with negative refractive power and includes a convex surface facing the image side. The sixth lens is with positive refractive power. The wide-angle lens assembly satisfies

$$1.8 \leq \frac{L 1 R 1 s}{f} \leq 4.0$$

wherein L1R1s is a radius of an object side surface of the first lens and f is an effective focal length of the wide-angle lens assembly.

### BACKGROUND OF THE INVENTION

Field of the Invention

The invention relates to a wide-angle lens assembly, especially for a wide-angle usage with miniaturization, less amounts of lens and better imaging quality.

Description of the Related Art

Recently, vehicular and electronic devices, such as smartphones, tablets, personal digital assistants (PDAs) and personal computers, have cameras for displaying, storing and taking pictures or videos. On the other hand, because of the development of smartphones and wireless internet, users could control surveillance systems by cell phones, which leads to a flourishing industry of Internet protocol cameras (IP cameras).

Above devices have been continually developed toward miniaturization. Therefore, the requirements for wide-angle lens assemblies with miniaturization and high resolution are greatly increased. However, the well-known lens assembly with miniaturization can't satisfy requirements of present. Therefore, a wide-angle lens assembly needs a new structure in order to meet the requirements of miniaturization and high resolution.

### BRIEF SUMMARY OF THE INVENTION

The invention provides a wide-angle lens assembly to solve the above problems. The wide-angle lens assembly of the invention, provided with characteristics of a shortened total lens length, an increased field of view, still has a good optical performance and can meet a requirement of resolution.

The wide-angle lens assembly in accordance with the invention comprises a first lens, a second lens, a third lens, a fourth lens, a fifth lens and a sixth lens, all of which are arranged in sequence from an object side to an image side along an optical axis. The first lens is a meniscus lens with negative refractive power and includes a convex surface facing the object side. The second lens is a biconcave lens with negative refractive power. The third lens is with positive refractive power. The fourth lens is with positive refractive power. The fifth lens is a meniscus lens with negative refractive power and includes a convex surface facing the image side. The sixth lens is with positive refractive power.

A radius of curvature of an object side surface of the second lens is greater than a radius of curvature of an image side surface of the second lens.

The third lens is a biconvex lens and includes convex surfaces facing both of the object side and the image side. Moreover, the fourth lens is a biconvex lens and includes convex surfaces facing both of the object side and the image side.

An image side surface of the fourth lens attaches to an object side surface of the fifth lens to become a compound lens.

The wide-angle lens assembly further comprises an aperture stop disposed between the third lens and the fifth lens, and controlling the amount of light on the image plan.

The sixth lens is a biconvex lens and includes convex surfaces facing both of the object side and the image side. Furthermore, the object side surface and the image side surface are aspheric.

The wide-angle lens assembly satisfies

$$0.125 \leq \frac{TL}{θ m} \leq 0.25 ,$$

wherein TL, total lens length, is an interval from the object side surface of the first lens to an image plan along the optical axis and θm is a half field of view (HFOV) presented by degrees.

The wide-angle lens assembly satisfies

$$- 3.0 \leq \frac{f 1}{L 1 R 2} \leq - 0.5 ,$$

wherein f1 is an effective focal length of the first lens and L1R2 is a radius of curvature of an image side surface of the first lens.

The wide-angle lens assembly satisfies

$$1.8 \leq \frac{L 1 R 1 s}{f} \leq 4.0 ,$$

wherein L1R1s is a radius of an object side surface of the first lens and f is an effective focal length of the wide-angle lens assembly.

The wide-angle lens assembly satisfies 37=(V4d−V5d)≦50, wherein V4d is an Abbe number of the fourth lens and V5d is an Abbe number of the fifth lens.

The wide-angle lens assembly in accordance with an exemplary embodiment of the invention includes a first lens, a second lens, a third lens, a fourth lens, a fifth lens and a sixth lens, all of which are arranged in sequence from an object side to an image side along an optical axis. The first lens is a meniscus lens with negative refractive power and includes a convex surface facing the object side. The second lens is a biconcave lens with negative refractive power. Furthermore, a radius of curvature of an object side surface of the second lens is greater than a radius of curvature of an image side surface of the second lens. The third lens is a biconvex lens with positive refractive power. The fourth lens is a biconvex lens with positive refractive power. The fifth lens is a meniscus lens with negative refractive power and includes a convex surface facing the image side. Additionally, an image side surface of the fourth lens attaches to an object side surface of the fifth lens to become a compound lens. The sixth lens is a biconvex lens with positive refractive power.

The wide-angle lens assembly in accordance with the invention includes a first lens, a second lens, a third lens, a fourth lens, a fifth lens and a sixth lens, all of which are arranged in sequence from an object side to an image side along an optical axis. The first lens is a meniscus lens with negative refractive power and includes a convex surface facing the object side. The second lens is a biconcave lens with negative refractive power. Furthermore, a radius of curvature of an object side surface of the second lens is greater than a radius of curvature of an image side surface of the second lens. The third lens is a biconvex lens with positive refractive power. The fourth lens is a biconvex lens with positive refractive power. The fifth lens is a meniscus lens with negative refractive power and includes a convex surface facing the image side. The sixth lens is a biconvex lens with positive refractive power. Additionally, the wide-angle lens assembly satisfies

$$0.125 \leq \frac{TL}{θ m} \leq 0.25 ,$$

wherein TL, total lens length, is an interval from the object side surface of the first lens to an image plan along the optical axis and θm is a half field of view (HFOV) presented by degrees.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a lens layout and optical path diagram of a wide-angle lens assembly in accordance with a first embodiment of the invention;

FIG. 2A is an astigmatic field curves diagram of the wide-angle lens assembly in accordance with the first embodiment of the invention;

FIG. 2B is a distortion diagram of the wide-angle lens assembly in accordance with the first embodiment of the invention;

FIG. 2C depicts a longitudinal spherical aberration of the wide-angle lens assembly in accordance with the first embodiment of the invention;

FIG. 3 is a lens layout and optical path diagram of a wide-angle lens assembly in accordance with a second embodiment of the invention;

FIG. 4A is an astigmatic field curves diagram of the wide-angle lens assembly in accordance with the second embodiment of the invention;

FIG. 4B is a distortion diagram of the wide-angle lens assembly in accordance with the second embodiment of the invention;

FIG. 4C depicts a longitudinal spherical aberration of the wide-angle lens assembly in accordance with the second embodiment of the invention;

FIG. 5 is a lens layout and optical path diagram of a wide-angle lens assembly in accordance with a third embodiment of the invention;

FIG. 6A is an astigmatic field curves diagram of the wide-angle lens assembly in accordance with the third embodiment of the invention;

FIG. 6B is a distortion diagram of the wide-angle lens assembly in accordance with the third embodiment of the invention;

FIG. 6C depicts a longitudinal spherical aberration of the wide-angle lens assembly in accordance with the third embodiment of the invention.

### DETAILED DESCRIPTION OF THE INVENTION

The following description is made for the purpose of illustrating the general principles of the invention and should not be taken in a limiting sense. The scope of the invention is best determined by reference to the appended claims.

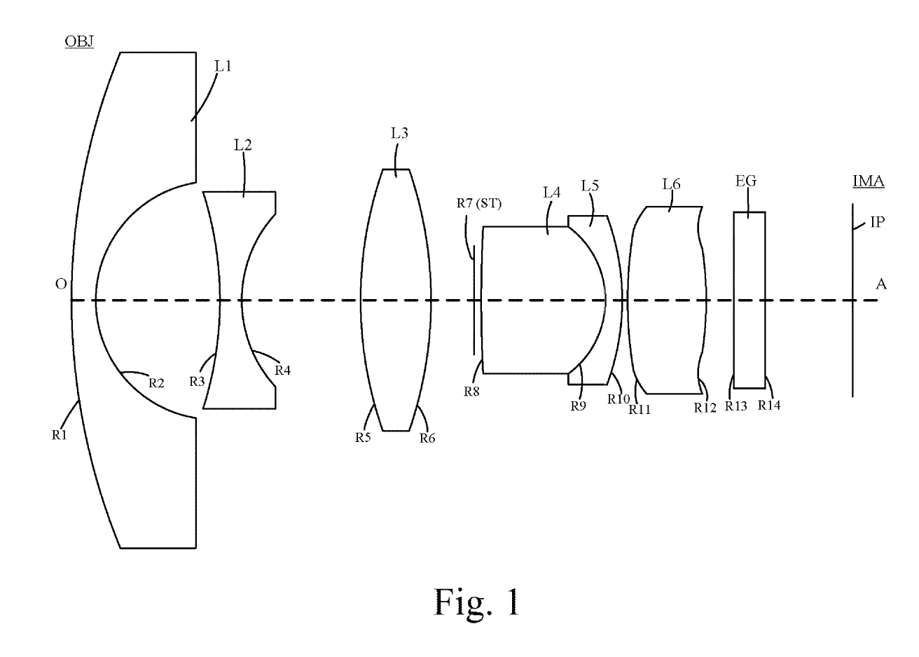

Referring to FIG. 1, FIG. 1 is a lens layout and optical path diagram of a wide-angle lens assembly in accordance with a first embodiment of the invention. The wide-angle lens assembly 1 includes a first lens L1, a second lens L2, a third lens L3, an aperture stop ST, a fourth lens L4, a fifth lens L5, a sixth lens L6, a glass EG and an image plan IP, all of which are arranged in sequence from an object side to an image side along an optical axis OA. The first lens L1 is a meniscus lens with negative refractive power, wherein the object side surface R1 is a convex surface, the image side surface R2 is a concave surface and a radius of curvature of the object side surface R1 is greater than a radius of curvature of the image side surface R2. The second lens L2 is a biconcave lens with negative refractive power, wherein the object side surface R3 is a concave surface, the image side surface R4 is a concave surface and a radius of curvature of the object side surface R3 is greater than a radius of curvature of the image side surface R4. The third lens L3 is a biconvex lens with positive refractive power, wherein the object side surface R5 is a convex surface, the image side surface R6 is a convex surface and a radius of curvature of the object side surface R5 is greater than a radius of curvature of the image side surface R6. The aperture stop ST controls the amount of light on the image plan IP, placed between the third lens L3 and the fifth lens L5. The fourth lens L4 is a biconvex lens with positive refractive power, wherein the object side surface R8 is a concave surface and the image side surface R9 is a convex surface. The fifth lens L5 is s meniscus lens with negative refractive power, wherein the object side surface R9 is a concave surface, the image side surface R10 is a convex surface and a radius of curvature of the image side surface R10 is greater than a radius of curvature of the object side surface R9. In addition, an image side surface R9 of the fourth lens L4 attaches to an object side surface R9 of the fifth lens L5 to become a compound lens, or the fourth lens L4 and the fifth lens L5 could be separated from each other by predetermined distance. The sixth lens L6 is a biconvex lens with positive refractive power, wherein the object side surface R11 is a convex surface, the image side surface R12 is a convex surface and both of the object side surface R11 and the image side surface R12 are aspheric surfaces. Furthermore, the sixth lens L6 could be made of plastic for an easily manufacture, less cost and a lighter assembly. Both of the object side surface R13 and image side surface R14 of the glass EG are plane surfaces.

In order to maintain excellent optical performance of the wide-angle lens assembly in accordance with the first embodiment of the invention, the wide-angle lens assembly 1 must satisfies one of the following four conditions:

$$\begin{matrix}0.125 \leq \frac{TL}{θ m} \leq 0.25 & ( 1 ) \\ - 3.0 \leq \frac{f 1}{L 1 R 2} \leq - 0.5 & ( 2 ) \\ 1.8 \leq \frac{L 1 R 1 s}{f} \leq 4.0 & ( 3 ) \\ 37 \leq ( V 4 d - V 5 d ) \leq 50 & ( 4 )\end{matrix}$$

wherein TL, total lens length, is an interval from the object side surface R1 of the first lens L1 to an image plan IP along the optical axis OA, θm is a half field of view (HFOV) presented by degrees, f1 is an effective focal length of the first lens L1, L1R2 is a radius of curvature of an image side surface R2 of the first lens L1, L1R1s is a radius of an object side surface R1 of the first lens L1, f is an effective focal length of the wide-angle lens assembly 1, V4d is an Abbe number of the fourth lens L4 and V5d is an Abbe number of the fifth lens L5.

By the above design of the lenses and stop ST, the wide-angle lens assembly 1 is provided with a shortened total lens length, an increased field of view, an effective corrected aberration and an increased resolution.

In order to achieve the above purposes and effectively enhance the optical performance, the wide-angle lens assembly 1 in accordance with the first embodiment of the invention is provided with the optical specifications shown in Table 1, which include the effective focal length, F-number, HFOV, total lens length, radius of curvature of each lens surface, thickness between adjacent surface, refractive index of each lens and Abbe number of each lens. Table 1 shows that the effective focal length is equal to 1.641 mm, F-number is equal to 2, HFOV is equal to 90° and total lens length is equal to 18.5132 mm for the wide-angle lens assembly 1 of the first embodiment of the invention.

TABLE 1
Effective Focal Length = 1.641 mm
F-number = 2
HFOV = 90°
Total Lens Length = 18.5132 mm

| | Radius of | | | | |
|---|---|---|---|---|---|
| Surface | Curvature | Thickness | | | |
| Number | (mm) | (mm) | Nd | Vd | Remark |
| R1 | 15.3405 | 0.604 | 1.52 | 60 | The First Lens L1 |
| R2 | 2.7506 | 2.882 | | | |
| R3 | −8.229 | 0.5 | 1.49 | 80 | The Second Lens L2 |
| R4 | 2.903 | 2.8 | | | |
| R5 | 9.0306 | 1.677 | 1.83 | 42.72 | The Third Lens L3 |
| R6 | −7.9318 | 0.9977 | | | |
| R7 | Inf | 0.127 | | | Stop ST1 |
| R8 | 11.869 | 2.905 | 1.59 | 68.62 | The Fourth Lens L4 |
| R9 | −2.10 | 0.432 | 1.84 | 24 | The Fifth Lens L5 |
| R10 | −5.197 | 0.126 | | | |
| R11 | 11.182 | 1.802 | 1.49 | 70.4 | The Sixth Lens L6 |
| R12 | −6.576 | 0.67 | | | |
| R13 | INF | 0.7 | 1.51 | 64.16 | Glass EG |
| R14 | INF | 2.0537 | | | |

The aspheric surface sag z of each lens in table 1 can be calculated by the following formula:

z=ch²/{1+[1−(k+1)c²h²]^{1/2}}+Ah⁴+Bh⁶+Ch⁸+Dh¹⁰+Eh¹²+Fh¹⁴+Gh¹⁶

where c is curvature, h is the vertical distance from the lens surface to the optical axis, k is conic constant and A, B, C, D, E, F and G are aspheric coefficients.

In the first embodiment, the conic constant k and the aspheric coefficients A, B, C, D, E, F, G of each surface are shown in Table 2.

TABLE 2

| Surface | | | | | | |
|---|---|---|---|---|---|---|
| Number | K | A4 | A6 | A8 | A10 | A12 |
| R11 | 0 | −4.458E−04 | 1.877E−03 | 0 | 0 | 0 |
| R12 | 0 | 3.668E−03 | 6.000E−04 | 2.721E−04 | 0 | 0 |

For the wide-angle lens assembly 1 of the first embodiment, the interval TL from the object side surface R1 of the first lens L1 to the image plane IP along the optical axis OA is equal to 18.5132 mm, the half field of view θm is equal to 90°, the effective focal length f1 of the first lens L1 is equal to −3.804 mm, the radius of curvature L1R2 of an image side surface R2 of the first lens L1 is equal to 2.7506 mm, is the radius L1R1s of an object side surface R1 of the first lens L1 is equal to 5.798 mm, the effective focal length f of the wide-angle lens assembly 1 is equal to 1.641 mm, the Abbe number V4d of the fourth lens L4 is equal to 68.62 and the Abbe number V5d of the fifth lens L5 is equal to 24. According to the above data, the following values can be obtained:

TL/θm=0.206,

f1/L1R2=−1.383,

L1R1s/f=3.533,

V4d−V5d=44.62,

which respectively satisfy the above conditions (1)-(4).

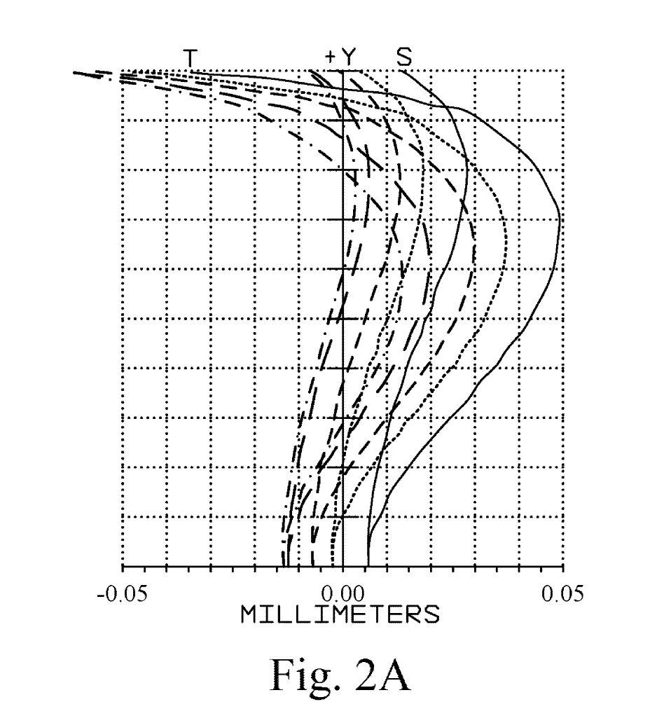

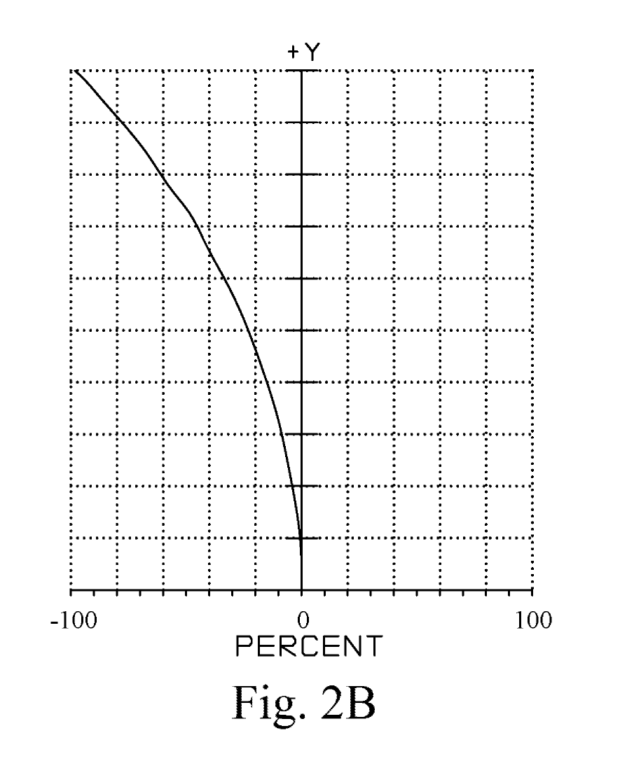

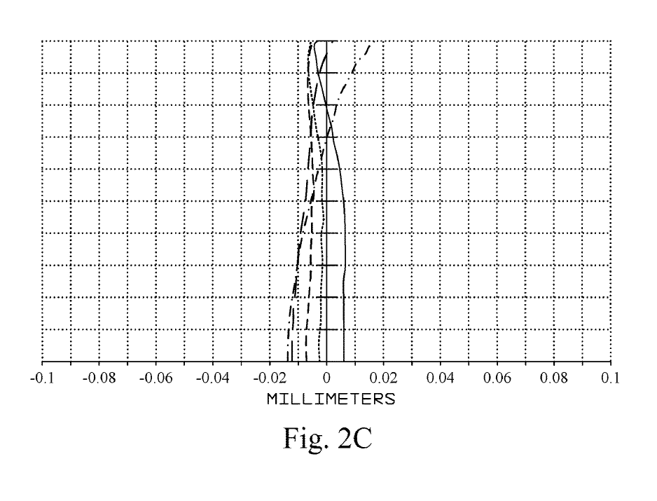

By the above arrangements of the lenses and stop ST, the wide-angle lens assembly 1 of the first embodiment can meet the requirements of optical performance as seen in FIGS. 2A-2C, wherein FIG. 2A shows an astigmatic field curves diagram of the wide-angle lens assembly 1 in accordance with the first embodiment of the invention, FIG. 2B shows a distortion diagram of the wide-angle lens assembly 1 in accordance with the first embodiment of the invention and FIG. 2C shows a longitudinal spherical aberration of the wide-angle lens assembly 1 in accordance with the first embodiment of the invention.

It can be seen from FIG. 2A that the astigmatic field curves of tangential direction and sagittal direction in the wide-angle lens assembly 1 of the first embodiment ranges from −0.055 mm to 0.04 mm for the wavelength of 587.5600 nm. It can be seen from FIG. 2B that the distortion in the wide-angle lens assembly 1 of the first embodiment ranges from −100% to 0% for the wavelength of 656.2800 nm. It can be seen from FIG. 2C that the longitudinal spherical aberration in the wide-angle lens assembly 1 of the first embodiment ranges from −0.015 mm to 0.02 mm for the wavelength of 435.8300 nm, 486.1300 nm, 546.0700 nm, 587.5600 nm and 656.2800 nm. It is obvious that, the astigmatic field curves, the distortion and the longitudinal spherical aberration of the wide-angle lens assembly 1 of the first embodiment can be corrected effectively. Therefore, the wide-angle lens assembly 1 of the first embodiment is capable of good optical performance.

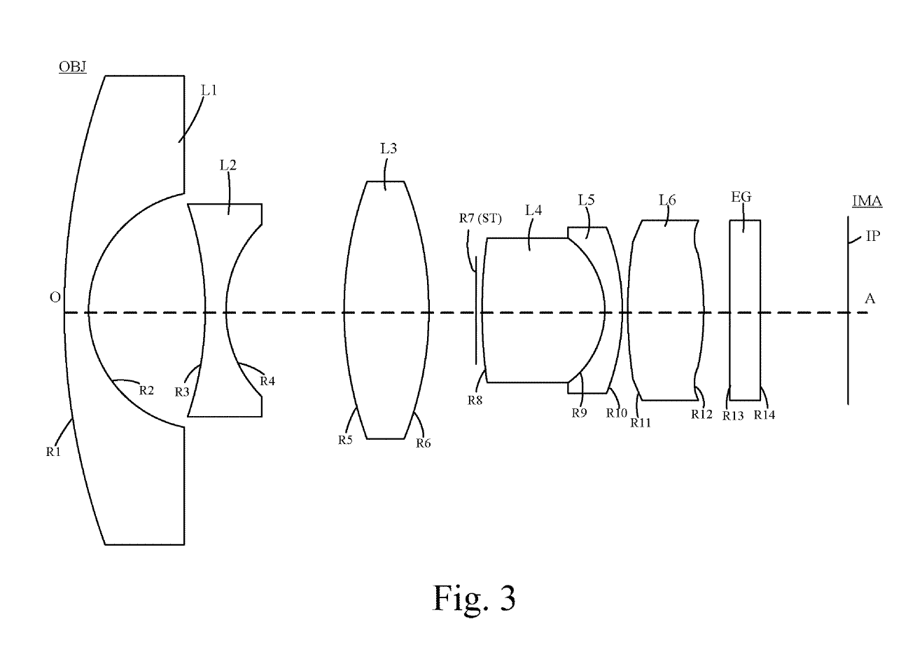

Referring to FIG. 3, FIG. 3 is a lens layout and optical path diagram of a wide-angle lens assembly in accordance with a second embodiment of the invention. The wide-angle lens assembly 2 includes a first lens L1, a second lens L2, a third lens L3, an aperture stop ST, a fourth lens L4, a fifth lens L5, a sixth lens L6, a glass EG and an image plan IP, all of which are arranged in sequence from an object side to an image side along an optical axis OA. The first lens L1 is a meniscus lens with negative refractive power, wherein the object side surface R1 is a convex surface, the image side surface R2 is a concave surface and a radius of curvature of the object side surface R1 is greater than a radius of curvature of the image side surface R2. The second lens L2 is a biconcave lens with negative refractive power, wherein the object side surface R3 is a concave surface, the image side surface R4 is a concave surface and a radius of curvature of the object side surface R3 is greater than a radius of curvature of the image side surface R4. The third lens L3 is a biconvex lens with positive refractive power, wherein the object side surface R5 is a convex surface, the image side surface R6 is a convex surface and a radius of curvature of the object side surface R5 is greater than a radius of curvature of the image side surface R6. The aperture stop ST controls the amount of light on the image plan IP, placed between the third lens L3 and the fifth lens L5. The fourth lens L4 is a biconvex lens with positive refractive power, wherein the object side surface R8 is a concave surface and the image side surface R9 is a convex surface. The fifth lens L5 is s meniscus lens with negative refractive power, wherein the object side surface R9 is a concave surface, the image side surface R10 is a convex surface and a radius of curvature of the image side surface R10 is greater than a radius of curvature of the object side surface R9. In addition, an image side surface R9 of the fourth lens L4 attaches to an object side surface R9 of the fifth lens L5 to become a compound lens, or the fourth lens L4 and the fifth lens L5 could be separated from each other by predetermined distance. The sixth lens L6 is a biconvex lens with positive refractive power, wherein the object side surface R11 is a convex surface, the image side surface R12 is a convex surface and both of the object side surface R11 and the image side surface R12 are aspheric surfaces. Furthermore, the sixth lens L6 could be made of plastic for an easily manufacture, less cost and a lighter assembly. Both of the object side surface R13 and image side surface R14 of the glass EG are plane surfaces.

In order to maintain excellent optical performance of the wide-angle lens assembly in accordance with the second embodiment of the invention, the wide-angle lens assembly 2 must satisfies one of the following four conditions:

$$\begin{matrix}0.125 \leq \frac{TL}{θ m} \leq 0.25 & ( 5 ) \\ - 3.0 \leq \frac{f 1}{L 1 R 2} \leq - 0.5 & ( 6 ) \\ 1.8 \leq \frac{L 1 R 1 s}{f} \leq 4.0 & ( 7 ) \\ 37 \leq ( V 4 d - V 5 d ) \leq 50 & ( 8 )\end{matrix}$$

wherein TL, total lens length, is an interval from the object side surface R1 of the first lens L1 to an image plan IP along the optical axis OA, θm is a half field of view (HFOV) presented by degrees, f1 is an effective focal length of the first lens L1, L1R2 is a radius of curvature of an image side surface R2 of the first lens L1, L1R1s is a radius of an object side surface R1 of the first lens L1 and f is an effective focal length of the wide-angle lens assembly 1, V4d is an Abbe number of the fourth lens L4 and V5d is an Abbe number of the fifth lens L5.

By the above design of the lenses and stop ST, the wide-angle lens assembly 2 is provided with a shortened total lens length, an increased field of view, an effective corrected aberration and an increased resolution.

In order to achieve the above purposes and effectively enhance the optical performance, the wide-angle lens assembly 2 in accordance with the second embodiment of the invention is provided with the optical specifications shown in Table 3, which include the effective focal length, F-number, HFOV, total lens length, radius of curvature of each lens surface, thickness between adjacent surface, refractive index of each lens and Abbe number of each lens. Table 3 shows that the effective focal length is equal to 1.6467 mm, F-number is equal to 2, HFOV is equal to 90° and total lens length is equal to 18.5133 mm for the wide-angle lens assembly 2 of the second embodiment of the invention.

TABLE 3
Effective Focal Length = 1.6467 mm
F-number = 2
HFOV = 90°
Total Lens Length = 18.5133 mm

| | Radius of | | | | |
|---|---|---|---|---|---|
| Surface | Curvature | Thickness | | | |
| Number | (mm) | (mm) | Nd | Vd | Remark |
| R1 | 15.823 | 0.59 | 1.54 | 59 | The First Lens L1 |
| R2 | 2.770 | 2.743 | | | |
| R3 | −7.689 | 0.5 | 1.47 | 70 | The Second Lens L2 |
| R4 | 2.912 | 2.808 | | | |
| R5 | 9.037 | 1.981 | 1.82 | 45 | The Third Lens L3 |
| R6 | −7.912 | 1.133 | | | |
| R7 | Inf | 0.127 | | | Stop ST1 |
| R8 | 11.8227 | 2.88 | 1.61 | 68 | The Fourth Lens L4 |
| R9 | −2.0894 | 0.432 | 1.85 | 24 | The Fifth Lens L5 |
| R10 | −5.202 | 0.127 | | | |
| R11 | 11.1129 | 1.176 | 1.49 | 70.4 | The Sixth Lens L6 |
| R12 | −6.47 | 0.67 | | | |
| R13 | INF | 0.7 | 1.51 | 64.16 | Glass EG |
| R14 | INF | 2.0537 | | | |

The aspheric surface sag z of each lens in table 3 can be calculated by the following formula:

z=ch²/{1+[1−(k+1)c²h²]^{1/2}}+Ah⁴+Bh⁶+Ch⁸+Dh¹⁰+Eh¹²+Fh¹⁴+Gh¹⁶

where c is curvature, h is the vertical distance from the lens surface to the optical axis, k is conic constant and A, B, C, D, E, F and G are aspheric coefficients.
In the second embodiment, the conic constant k and the aspheric coefficients A, B, C, D, E, F, G of each surface are shown in Table 4.

TABLE 4

| Surface | | | | | | |
|---|---|---|---|---|---|---|
| Number | K | A4 | A6 | A8 | A10 | A12 |
| R11 | 0 | −4.458E−04 | 1.842E−03 | −1.181E−05 | −3.119E−06 | 0 |
| R12 | 0 | 3.418E−03 | 5.929E−04 | 2.815E−04 | 0 | 0 |

For the wide-angle lens assembly 2 of the second embodiment, the interval TL from the object side surface R1 of the first lens L1 to the image plane IP along the optical axis OA is equal to 18.5133 mm, the half field of view θm is equal to 90°, the effective focal length f1 of the first lens L1 is equal to −6.713 mm, the radius of curvature L1R2 of an image side surface R2 of the first lens L1 is equal to 2.770 mm, is the radius L1R1s of an object side surface R1 of the first lens L1 is equal to 5.518 mm, the effective focal length f of the wide-angle lens assembly 2 is equal to 1.6467 mm, the Abbe number V4d of the fourth lens L4 is equal to 68 and the Abbe number V5d of the fifth lens L5 is equal to 24. According to the above data, the following values can be obtained:

TL/θm=0.206,

f1/L1R2=−2.423,

L1R1s/f=3.351,

V4d−V5d=44,

which respectively satisfy the above conditions (5)-(8).

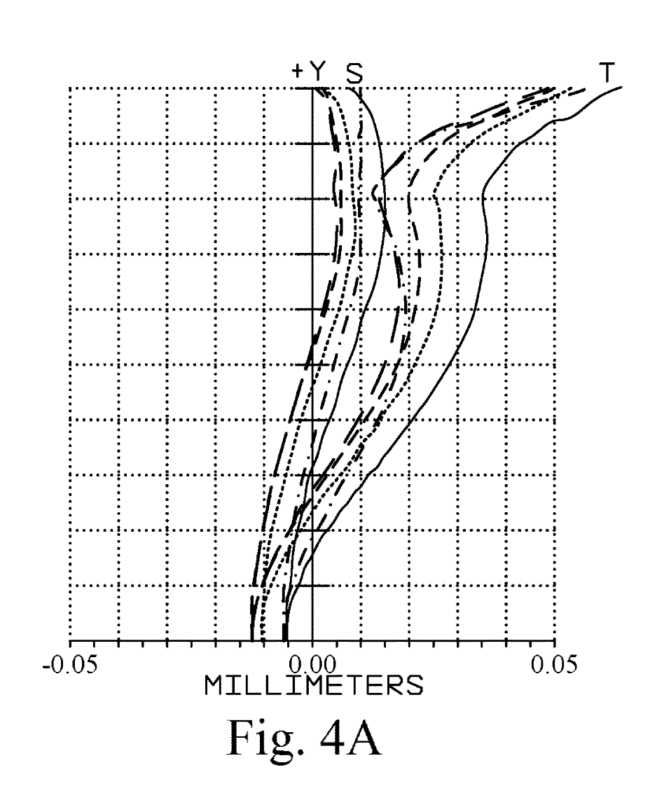

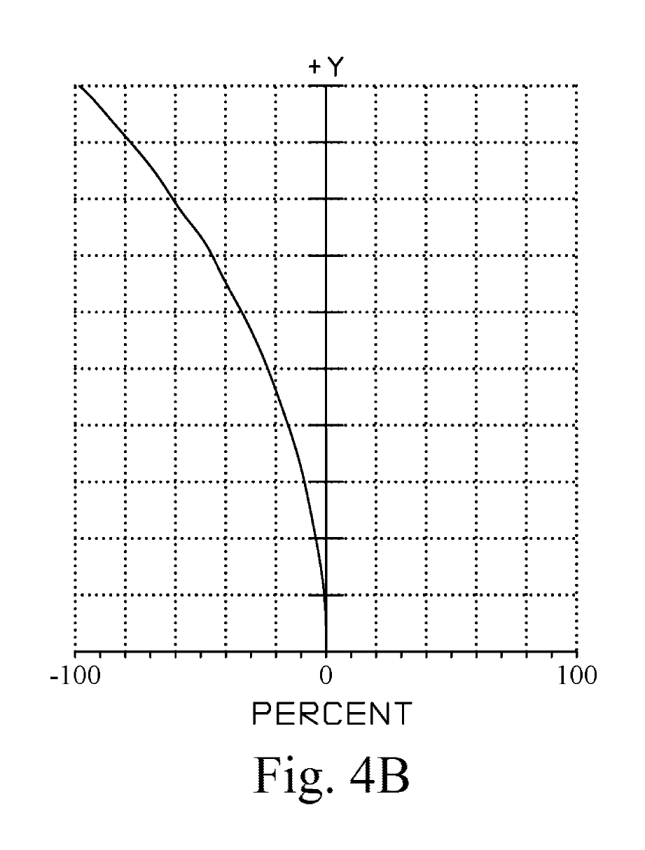

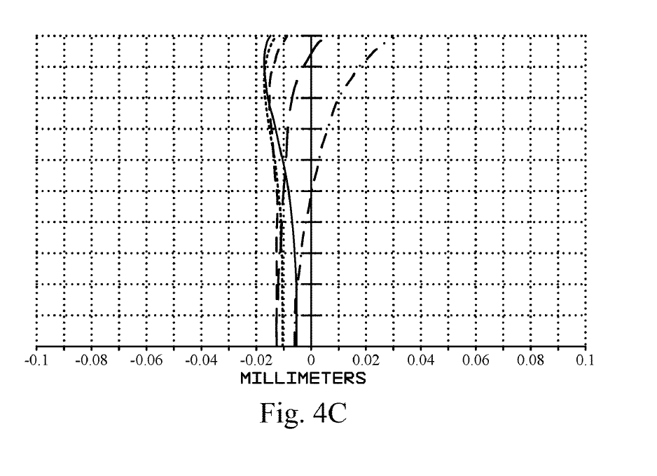

By the above arrangements of the lenses and stop ST, the wide-angle lens assembly 2 of the second embodiment can meet the requirements of optical performance as seen in FIGS. 4A-4C, wherein FIG. 4A shows an astigmatic field curves diagram of the wide-angle lens assembly 2 in accordance with the second embodiment of the invention, FIG. 4B shows a distortion diagram of the wide-angle lens assembly 2 in accordance with the second embodiment of the invention and FIG. 4C shows a longitudinal spherical aberration of the wide-angle lens assembly 2 in accordance with the second embodiment of the invention.

It can be seen from FIG. 4A that the astigmatic field curves of tangential direction and sagittal direction in the wide-angle lens assembly 2 of the second embodiment ranges from −0.0125 mm to 0.055 mm for the wavelength of 587.5600 nm. It can be seen from FIG. 4B that the distortion in the wide-angle lens assembly 2 of the second embodiment ranges from −100% to 0% for the wavelength of 656.2800 nm. It can be seen from FIG. 4C that the longitudinal spherical aberration in the wide-angle lens assembly 2 of the second embodiment ranges from −0.02 mm to 0.03 mm for the wavelength of 435.8300 nm, 486.1300 nm, 546.0700 nm, 587.5600 nm and 656.2800 nm. It is obvious that, the astigmatic field curves, the distortion and the longitudinal spherical aberration of the wide-angle lens assembly 2 of the second embodiment can be corrected effectively. Therefore, the wide-angle lens assembly 2 of the second embodiment is capable of good optical performance.

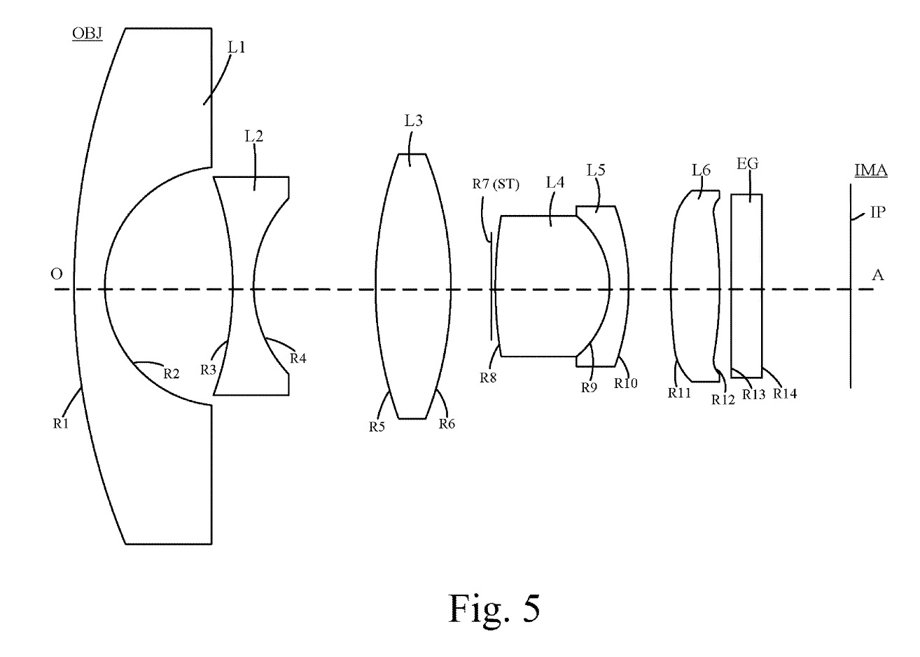

Referring to FIG. 5, FIG. 5 is a lens layout and optical path diagram of a wide-angle lens assembly in accordance with a third embodiment of the invention. The wide-angle lens assembly 3 includes a first lens L1, a second lens L2, a third lens L3, an aperture stop ST, a fourth lens L4, a fifth lens L5, a sixth lens L6, a glass EG and an image plan IP, all of which are arranged in sequence from an object side to an image side along an optical axis OA. The first lens L1 is a meniscus lens with negative refractive power, wherein the object side surface R1 is a convex surface, the image side surface R2 is a concave surface and a radius of curvature of the object side surface R1 is greater than a radius of curvature of the image side surface R2. The second lens L2 is a biconcave lens with negative refractive power, wherein the object side surface R3 is a concave surface, the image side surface R4 is a concave surface and a radius of curvature of the object side surface R3 is greater than a radius of curvature of the image side surface R4. The third lens L3 is a biconvex lens with positive refractive power, wherein the object side surface R5 is a convex surface, the image side surface R6 is a convex surface and a radius of curvature of the object side surface R5 is greater than a radius of curvature of the image side surface R6. The aperture stop ST controls the amount of light on the image plan IP, placed between the third lens L3 and the fifth lens L5. The fourth lens L4 is a biconvex lens with positive refractive power, wherein the object side surface R8 is a concave surface and the image side surface R9 is a convex surface. The fifth lens L5 is s meniscus lens with negative refractive power, wherein the object side surface R9 is a concave surface, the image side surface R10 is a convex surface and a radius of curvature of the image side surface R10 is greater than a radius of curvature of the object side surface R9. In addition, an image side surface R9 of the fourth lens L4 attaches to an object side surface R9 of the fifth lens L5 to become a compound lens, or the fourth lens L4 and the fifth lens L5 could be separated from each other by predetermined distance. The sixth lens L6 is a biconvex lens with positive refractive power, wherein the object side surface R11 is a convex surface, the image side surface R12 is a convex surface and both of the object side surface R11 and the image side surface R12 are aspheric surfaces. Furthermore, the sixth lens L6 could be made of plastic for an easily manufacture, less cost and a lighter assembly. Both of the object side surface R13 and image side surface R14 of the glass EG are plane surfaces.

In order to maintain excellent optical performance of the wide-angle lens assembly in accordance with the third embodiment of the invention, the wide-angle lens assembly 3 must satisfies one of the following four conditions:

$$\begin{matrix}0.125 \leq \frac{TL}{θ m} \leq 0.25 & ( 9 ) \\ - 3.0 \leq \frac{f 1}{L 1 R 2} \leq - 0.5 & ( 10 ) \\ 1.8 \leq \frac{L 1 R 1 s}{f} \leq 4.0 & ( 11 ) \\ 37 \leq ( V 4 d - V 5 d ) \leq 50 & ( 12 )\end{matrix}$$

wherein TL, total lens length, is an interval from the object side surface R1 of the first lens L1 to an image plan IP along the optical axis OA, θm is a half field of view (HFOV) presented by degrees, f1 is an effective focal length of the first lens L1, L1R2 is a radius of curvature of an image side surface R2 of the first lens L1, L1R1s is a radius of an object side surface R1 of the first lens L1 and f is an effective focal length of the wide-angle lens assembly 1, V4d is an Abbe number of the fourth lens L4 and V5d is an Abbe number of the fifth lens L5.

By the above design of the lenses and stop ST, the wide-angle lens assembly 2 is provided with a shortened total lens length, an increased field of view, an effective corrected aberration and an increased resolution.

In order to achieve the above purposes and effectively enhance the optical performance, the wide-angle lens assembly 3 in accordance with the third embodiment of the invention is provided with the optical specifications shown in Table 5, which include the effective focal length, F-number, HFOV, total lens length, radius of curvature of each lens surface, thickness between adjacent surface, refractive index of each lens and Abbe number of each lens. Table 5 shows that the effective focal length is equal to 1.5833 mm, F-number is equal to 2, HFOV is equal to 90° and total lens length is equal to 18.0192 mm for the wide-angle lens assembly 3 of the third embodiment of the invention.

TABLE 5
Effective Focal Length = 1.5833 mm
F-number = 2
HFOV = 90°
Total Lens Length = 18.0192 mm

| | Radius of | | | | |
|---|---|---|---|---|---|
| Surface | Curvature | Thickness | | | |
| Number | (mm) | (mm) | Nd | Vd | Remark |
| R1 | 15.6 | 0.7 | 1.52 | 65 | The First Lens L1 |
| R2 | 2.734 | 2.932 | | | |
| R3 | −7.709 | 0.5 | 1.48 | 85 | The Second Lens L2 |
| R4 | 2.935 | 2.808 | | | |
| R5 | 8.715 | 1.743 | 1.834 | 42.72 | The Third Lens L3 |
| R6 | −7.686 | 0.91 | | | |
| R7 | Inf | 0.127 | | | Stop ST1 |
| R8 | 11.694 | 2.626 | 1.6 | 68.62 | The Fourth Lens L4 |
| R9 | −2.018 | 0.432 | 1.81 | 24 | The Fifth Lens L5 |
| R10 | −5.192 | 0.985 | | | |
| R11 | 14.789 | 1.1 | 1.53 | 70.4 | The Sixth Lens L6 |
| R12 | −6.386 | 0.288 | | | |
| R13 | INF | 0.7 | 1.51 | 64.16 | Glass EG |
| R14 | INF | 2.0667 | | | |

The aspheric surface sag z of each lens in table 5 can be calculated by the following formula:

z=ch²/{1+[1−(k+1)c²h²]^{1/2}}+Ah⁴+Bh⁶+Ch⁸+Dh¹⁰+Eh¹²+Fh¹⁴+Gh¹⁶

where c is curvature, h is the vertical distance from the lens surface to the optical axis, k is conic constant and A, B, C, D, E, F and G are aspheric coefficients.

In the third embodiment, the conic constant k and the aspheric coefficients A, B, C, D, E, F, G of each surface are shown in Table 6.

TABLE 6

| Surface | | | | | | |
|---|---|---|---|---|---|---|
| Number | K | A4 | A6 | A8 | A10 | A12 |
| R11 | 0 | −4.908E−04 | 2.524E−03 | 1.020E−04 | −1.233E−06 | 0 |
| R12 | 0 | 4.309E−03 | 1.682E−03 | 2.810E−04 | 2.192E−05 | 9.818E−06 |

For the wide-angle lens assembly 3 of the third embodiment, the interval TL from the object side surface R1 of the first lens L1 to the image plane IP along the optical axis OA is equal to 18.0192 mm, the half field of view θm is equal to 90°, the effective focal length f1 of the first lens L1 is equal to −6.914 mm, the radius of curvature L1R2 of an image side surface R2 of the first lens L1 is equal to 2.734 mm, is the radius L1R1s of an object side surface R1 of the first lens L1 is equal to 5.949 mm, the effective focal length f of the wide-angle lens assembly 3 is equal to 1.5833 mm, the Abbe number V4d of the fourth lens L4 is equal to 68.62 and the Abbe number V5d of the fifth lens L5 is equal to 24. According to the above data, the following values can be obtained:

TL/θm=0.2,

f1/L1R2=−2.529,

L1R1s/f=3.757,

V4d−V5d=44.62,

which respectively satisfy the above conditions (9)-(12).

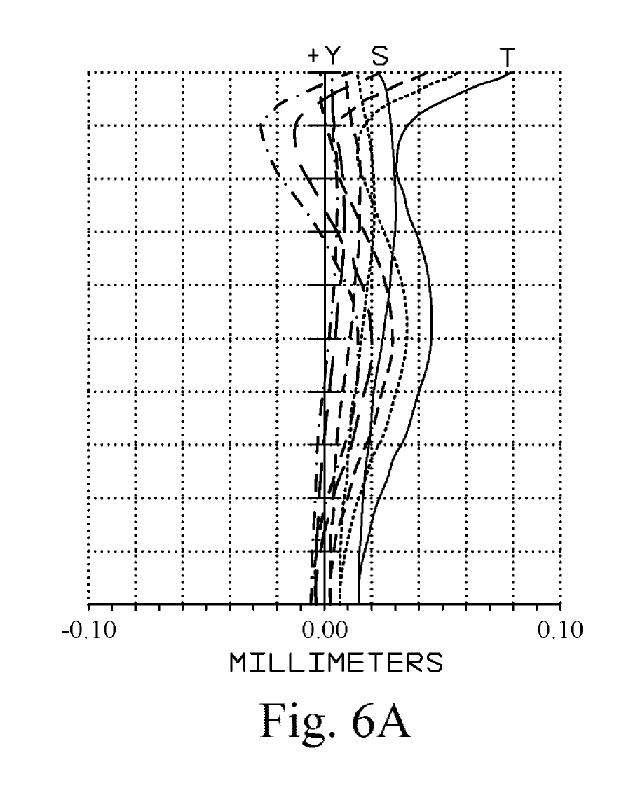

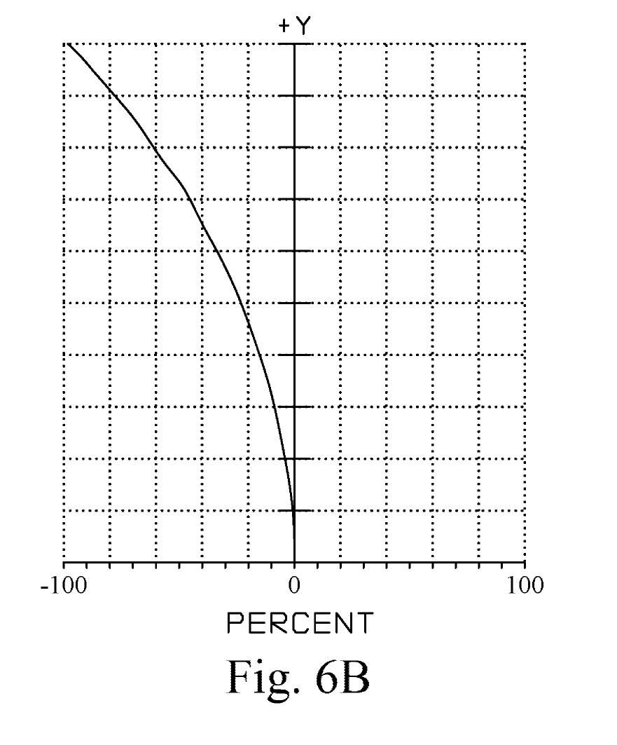

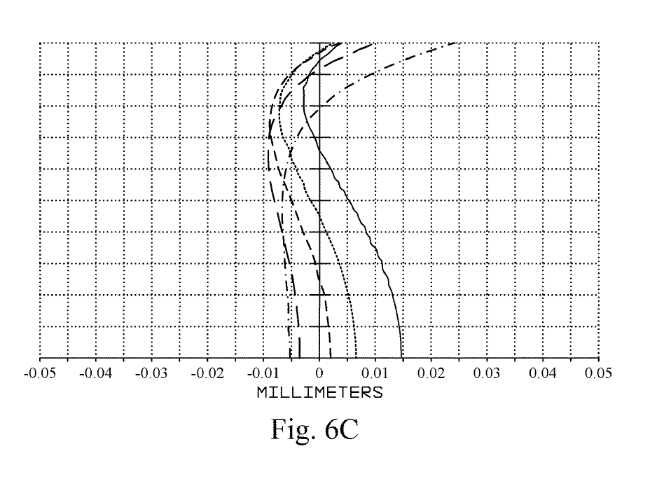

By the above arrangements of the lenses and stop ST, the wide-angle lens assembly 3 of the third embodiment can meet the requirements of optical performance as seen in FIGS. 6A-6C, wherein FIG. 6A shows an astigmatic field curves diagram of the wide-angle lens assembly 3 in accordance with the third embodiment of the invention, FIG. 6B shows a distortion diagram of the wide-angle lens assembly 3 in accordance with the third embodiment of the invention and FIG. 6C shows a longitudinal spherical aberration of the wide-angle lens assembly 3 in accordance with the third embodiment of the invention.

It can be seen from FIG. 6A that the astigmatic field curves of tangential direction and sagittal direction in the wide-angle lens assembly 3 of the third embodiment ranges from 0.006 mm to 0.06 mm for the wavelength of 587.5600 nm. It can be seen from FIG. 6B that the distortion in the wide-angle lens assembly 3 of the third embodiment ranges from −100% to 0% for the wavelength of 656.2800 nm. It can be seen from FIG. 6C that the longitudinal spherical aberration in the wide-angle lens assembly 3 of the third embodiment ranges from −0.01 mm to 0.025 mm for the wavelength of 435.8300 nm, 486.1300 nm, 546.0700 nm, 587.5600 nm and 656.2800 nm. It is obvious that, the astigmatic field curves, the distortion and the longitudinal spherical aberration of the wide-angle lens assembly 3 of the third embodiment can be corrected effectively. Therefore, the wide-angle lens assembly 3 of the third embodiment is capable of good optical performance.

In the above embodiments, any of the object side surfaces or image side surfaces of the first, second, third, fourth, fifth and sixth lens are aspheric surfaces. Besides, a radius of curvature of the object side surface could be less than a radius of curvature of the image side surface. The mentioned changes have the same effect and falls into the scope of the invention.

What is claimed is:

1. A wide-angle lens assembly comprising:
a first lens which is a meniscus lens with negative refractive power and comprises a convex surface facing the object side;
a second lens which is a biconcave lens with negative refractive power;
a third lens which is with positive refractive power;
a fourth lens which is with positive refractive power;
a fifth lens which is a meniscus lens with negative refractive power and comprises a convex surface facing the image side; and
a sixth lens which is with positive refractive power;
wherein the first lens, the second lens, the third lens, the fourth lens, the fifth lens and the sixth lens are arranged in sequence from an object side to an image side along an optical axis of the wide-angle lens assembly,
wherein the wide-angle lens assembly satisfies:
$$1.8 \leq \frac{L 1 R 1 s}{f} \leq 4.0$$
wherein L1R1s is a radius of an object side surface of the first lens and f is an effective focal length of the wide-angle lens assembly.

2. The wide-angle lens assembly as claimed in claim 1, wherein a radius of curvature of an object side surface of the second lens is greater than a radius of curvature of an image side surface of the second lens.

3. The wide-angle lens assembly as claimed in claim 1, wherein:
the third lens is a biconvex lens and comprises a convex surface facing the object side and a convex surface facing the image side; and
the fourth lens is a biconvex lens and comprises a convex surface facing the object side and a convex surface facing the image side.

4. The wide-angle lens assembly as claimed in claim 1, wherein an image side surface of the fourth lens attaches to an object side surface of the fifth lens to become a compound lens.

5. The wide-angle lens assembly as claimed in claim 1, further comprising an aperture stop disposed between the third lens and the fifth lens, and controlling the amount of light on the image plan.

6. The wide-angle lens assembly as claimed in claim 4, further comprising an aperture stop disposed between the third lens and the fifth lens, and controlling the amount of light on the image plan.

7. The wide-angle lens assembly as claimed in claim 1, wherein the sixth lens is a biconvex lens and comprises a convex surface facing the object side and a convex surface facing the image side,
wherein both of the object side surface of the sixth lens and the image side surface of the sixth lens are aspheric surfaces.

8. The wide-angle lens assembly as claimed in claim 1, further satisfying:
$$0.125 \leq \frac{TL}{θ m} \leq 0.25$$
wherein TL is an interval from the object side surface of the first lens to an image plan along the optical axis and θm is a half field of view presented by degrees.

9. The wide-angle lens assembly as claimed in claim 1, further satisfying:
$$- 3.0 \leq \frac{f 1}{L 1 R 2} \leq - 0.5$$
wherein f1 is an effective focal length of the first lens and L1R2 is a radius of curvature of an image side surface of the first lens.

10. A wide-angle lens assembly comprising:
a first lens which is a meniscus lens with negative refractive power and comprises a convex surface facing the object side;
a second lens which is a biconcave lens with negative refractive power;
a third lens which is with positive refractive power;
a fourth lens which is with positive refractive power;
a fifth lens which is a meniscus lens with negative refractive power and comprises a convex surface facing the image side; and
a sixth lens which is with positive refractive power;
wherein the first lens, the second lens, the third lens, the fourth lens, the fifth lens and the sixth lens are arranged in sequence from an object side to an image side along an optical axis of the wide-angle lens assembly,
wherein the wide-angle lens assembly satisfies:
37≦(V4d−V5d)≦50
wherein V4d is an Abbe number of the fourth lens and V5d is an Abbe number of the fifth lens.

11. The wide-angle lens assembly as claimed in claim 10, wherein a radius of curvature of an object side surface of the second lens is greater than a radius of curvature of an image side surface of the second lens.

12. The wide-angle lens assembly as claimed in claim 10, wherein:
the third lens is a biconvex lens and comprises a convex surface facing the object side and a convex surface facing the image side; and
the fourth lens is a biconvex lens and comprises a convex surface facing the object side and a convex surface facing the image side.

13. The wide-angle lens assembly as claimed in claim 10, wherein an image side surface of the fourth lens attaches to an object side surface of the fifth lens to become a compound lens.

14. The wide-angle lens assembly as claimed in claim 10, further comprising an aperture stop disposed between the third lens and the fifth lens, and controlling the amount of light on the image plan.

15. The wide-angle lens assembly as claimed in claim 10, wherein the sixth lens is a biconvex lens and comprises a convex surface facing the object side and a convex surface facing the image side,
wherein both of the object side surface of the sixth lens and the image side surface of the sixth lens are aspheric surfaces.

16. The wide-angle lens assembly as claimed in claim 10, further satisfying:
$$0.125 \leq \frac{TL}{θ m} \leq 0.25$$
wherein TL is an interval from the object side surface of the first lens to an image plan along the optical axis and θm is a half field of view presented by degrees.

17. The wide-angle lens assembly as claimed in claim 13, further satisfying:
$$0.125 \leq \frac{TL}{θ m} \leq 0.25$$
wherein TL is an interval from the object side surface of the first lens to an image plan along the optical axis and θm is a half field of view presented by degrees.

18. The wide-angle lens assembly as claimed in claim 10, further satisfying:
$$- 3.0 \leq \frac{f 1}{L 1 R 2} \leq - 0.5$$
wherein f1 is an effective focal length of the first lens and L1R2 is a radius of curvature of an image side surface of the first lens.

19. The wide-angle lens assembly as claimed in claim 10, further satisfying:
$$1.8 \leq \frac{L 1 R 1 s}{f} \leq 4.0$$
wherein L1R1s is a radius of an object side surface of the first lens and f is an effective focal length of the wide-angle lens assembly.

20. A wide-angle lens assembly comprising:
a first lens which is a meniscus lens with negative refractive power and comprises a convex surface facing the object side;
a second lens which is a biconcave lens with negative refractive power;
a third lens which is with positive refractive power;
a fourth lens which is with positive refractive power;
a fifth lens which is a meniscus lens with negative refractive power and comprises a convex surface facing the image side; and
wherein the first lens, the second lens, the third lens, the fourth lens, the fifth lens and the sixth lens are arranged in sequence from an object side to an image side along an optical axis of the wide-angle lens assembly,
wherein the wide-angle lens assembly satisfies:
$$1.8 \leq \frac{L 1 R 1 s}{f} \leq 4.0$$
$$0.125 \leq \frac{TL}{θ m} \leq 0.25 \\ - 3.0 \leq \frac{f 1}{L 1 R 2} \leq - 0.5$$
$$37 \leq ( V 4 d - V 5 d ) \leq 50$$
wherein L1R1s is a radius of an object side surface of the first lens, f is an effective focal length of the wide-angle lens assembly, TL is an interval from the object side surface of the first lens to an image plan along the optical axis, θm is a half field of view presented by degrees, f1 is an effective focal length of the first lens, L1R2 is a radius of curvature of an image side surface of the first lens, V4d is an Abbe number of the fourth lens L4 and V5d is an Abbe number of the fifth lens.
